(19) United States
(12) Patent Application Publication
(10) Pub. No.: US 2004/0041776 A1
(43) Pub. Date: Mar. 4, 2004

(54) Electro-optical device, driver circuit for electro-optical device, drive method for driving electro-optical device, and electronic equipment

(75) Inventor: Magoyuki Yokokawa, Matsumoto-si (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/609,665

(22) Filed: Jul. 1, 2003

(30) Foreign Application Priority Data
Jul. 25, 2002 (JP) 2002-216762

(51) Int. Cl. G09G 3/36

(52) U.S. Cl. 345/99

(57) ABSTRACT

An image signal processor circuit outputs image signals. A data line driver circuit generates sampling control signals to sample the image signals, by using a clock and an enable signal. A timing generator sets active periods of the enable signal which make the sampling possible, in periods which are other than periods including the rise or fall timings of the clock. Thus, the clock neither rises nor falls at timings at which the image signals are sampled, so that high frequency noise ascribable to the clock can be reduced or prevented from mixing into the image signals.

### BACKGROUND OF THE INVENTION

1. Field of Invention

The present invention relates to an electro-optical device of an active matrix scheme, a driver circuit for an electro-optical device, a drive method to drive an electrooptical device, and an electronic equipment.

2. Description of Related Art

In general, a related art electro-optical device, such as a liquid crystal device which presents a predetermined display by employing a liquid crystal as an electro-optical substance, is so constructed that the liquid crystal is sandwiched in between a pair of substrates. Particularly in an electro-optical device, such as a liquid crystal device of an active-matrix drive scheme based on TFT drive, TFD drive or the like, a TFT array substrate or the like is overlaid with large numbers of scanning lines and data lines which are respectively arrayed vertically and laterally, a large number of pixel electrodes which are disposed in correspondence with the intersection points of the scanning lines and the data lines, and so forth.

The individual scanning lines are sequentially fed with scanning signals from a scanning line driver circuit. On the other hand, the data lines are fed with image signals by a sampling circuit, which is driven by a data line driver circuit. More specifically, the data line driver circuit is constructed so as to feed a sampling circuit, by which image signals on an image signal line are sampled for the respective data lines, with sampling circuit drive signals in parallel with the sequential feed operations of the scanning signals.

The data line driver circuit includes, in general, a plurality of latch circuits (a shift register circuit), which sequentially shift a transfer signal fed at the outset of a horizontal scanning period in accordance with a clock signal, and which output the shifted signals as the sampling signals. Likewise, the scanning line driver circuit includes a plurality of latch circuits, which sequentially shift a transfer signal fed at the outset of a vertical scanning period in accordance with a clock signal, and which output the shifted signals as the scanning signals. The sampling circuit includes sampling switches which are disposed for the respective data lines, and by which the image signals fed from outside are sampled in accordance with the sampling signals based on the data line driver circuit, so as to be fed to the corresponding data lines.

Accordingly, the sampling signals of the respective data lines need to be generated exclusively from one another. Nevertheless, the sampling signals are sometimes outputted in overlapping fashion for any reason. Then, the image signal which needs to be sampled by one of the data lines is also sampled by the data line adjacent to this line. This results in the problem that so-called “ghost”, “cross-talk” or the like occurs to degrade a display quality.

The related art includes a technique to cope with the heightened frequency of dot clocks, such that an image signal of one loop is subjected to serial-to-parallel conversion (phase expansion) into a plurality of m loops, and the resulting image signals of the m loops are simultaneously sampled in accordance with a sampling signal so as to be fed onto m data lines. When the sampling signal is outputted in overlapping fashion in such a technique, the ghost, the cross-talk or the like appears in units of m lines, and hence, degradation in a display quality becomes a more serious problem.

Therefore, a related art enable circuit can be introduced in order to reduce or prevent the sampling signal from overlapping. The enable circuit includes a technique such that, in order to reduce or prevent the sampling switches from sampling image signals in accordance with successive sampling circuit drive signals which overlap on a time axis, the logical products between an enabling clock signal called an “enable signal” and the respective sampling circuit drive signals are taken, thereby to narrow the pulse width of each of the sampling circuit drive signals to the pulse width of the enable signal.

Some time interval is set as a temporal margin between the two successive sampling circuit drive signals by limiting the pulse width in this manner. Therefore, even when adverse effects such as ON resistances, wiring resistances, time constants, capacitances and delay times in active elements and various wiring lines of TFTs or the like, which constitute the sampling circuit, the data line driver circuit, etc., are relatively intensified with high frequency drive, the adverse effect can be partially or completely absorbed by the temporal margin stated above.

As a result, it is possible to reduce or efficiently prevent the so-called “cross-talk” or “ghost” from appearing between the data lines which are adjacent to each other, in a case where the image signals are not phase-expanded, or between the data lines which are connected to the identical image signal and which are successively driven, in a case where the image signals are phase-expanded.

Meanwhile, the above mentioned shift register circuit is constructed so as to generate transfer signals at individual stages on the basis of an X-side clock signal CLX which is inputted from an image signal processor circuit located outside and which serves as the reference of horizontal scanning (and the inverted signal CLXᵢₙᵥ thereof), and an enable signal ENB, and to output the transfer signals as the sampling circuit drive signals to the sampling switches which are connected to the corresponding scanning lines, respectively.

However, when the rises or falls of the clock signal CLX or the inverted signal CLXᵢₙᵥ thereof and the enable signal ENB occurs substantially at the same time, the level of high frequency noise which mixes into the image signal to be fed to the data line becomes conspicuously high. The high frequency noise is displayed as a vertical line blur on a screen, and incurs the problem of degrading a screen quality.

### SUMMARY OF THE INVENTION

The present invention address the above and/or other problems, and provides an electro-optical device and an electronic equipment in which the logical status of a clock signal CLX or the inverted signal CLXᵢₙᵥ thereof is prevented from changing in an active enable signal period and a period vicinal thereto, whereby the level of noise to be mixed into an image signal can be lowered to suppress a vertical line blur.

An electro-optical device according to the present invention includes a plurality of scanning lines and a plurality of data lines, switching elements which are disposed in correspondence with intersection parts between the scanning lines and the data lines, pixel electrodes which are disposed in correspondence with the switching elements, and video signal lines which transmit image signals. Further, the device includes a data line drive device to sample the image signals transferred by the video signal lines and feeding them to the data lines, by using a clock which serves as reference of horizontal scanning and an enable signal which determines timings to feed the image signals to the data lines, and a timing generation device to set active periods of the enable signal which make the sampling of the image signals possible, in periods which do not include timings of rise or fall of the clock.

According to such a construction, the data line drive device samples the image signals transferred via the video signal lines and feeds them to the individual data lines by using the reference clock of the horizontal scanning and the enable signal. The timing generation device sets active periods of the enable signal which make the sampling of the image signals possible, in the periods which do not include the timings of the rise or fall of the clock. That is, neither the rise nor fall of the clock arises within the active periods of the enable signal which sets sampling periods. Accordingly, high frequency noises ascribable to the rise and fall of the clock can be reduced or prevented from mixing into the image signals in the periods in which the image signals are being fed to the data lines. Since the timing of the rise or fall of the clock and that of the rise or fall of the enable signal do not coincide, it does not occur that the noises of both the clock and the enable signal are superposed to drastically enlarge the noise level of the image signals. Thus, the level of noise to be mixed into the image signals can be reduced to prevent line blurs in a vertical direction from being displayed on a screen and to enhance a screen quality.

The electro-optical device is provided such that the timing generation device sets the active periods of the enable signal, in periods which are other than a period of predetermined width including the timing of the rise or fall of the clock.

According to such a construction, the rise and fall of the enable signal arise at timings, which are distant from the rise and fall of the clock more than the period of the predetermined width. Accordingly, the level of the sum between noise ascribable to the clock and noise ascribable to the enable signal is comparatively small, so that the level of high frequency noise to be mixed into the image signals which are fed to the data lines is sufficiently reduced.

The electro-optical device is provided such that the period of the predetermined width is a period, which is distant from the timing of the rise or fall of the clock more than 15 nanoseconds.

According to such a construction, the influences of noises ascribable to the rises or falls of the enable signal and the clock are sufficiently relieved, so that image signals of high screen quality can be obtained.

The electro-optical device is provided such that the enable signal has a plurality of active periods within one cycle of the clock, which serves as the reference of the horizontal scanning.

According to such a construction, the image signals can be fed to a plurality of data lines based on the enable signals in time division within one cycle of the clock, so that a clock frequency can be lowered.

An electronic equipment according to the present invention includes the above electro-optical device as the image formation device.

According to such a construction, the high frequency noises are reduced or prevented from mixing into the image signals in the above electro-optical device, so that an image of high image quality free from line blurs can be obtained.

### BRIEF DESCRIPTION OF THE DRAWINGS

FIG. 1 is a schematic showing an electro-optical device according to a first exemplary embodiment of the present invention;

FIG. 2 is a perspective view showing the construction of a liquid crystal panel 100 in FIG. 1;

FIG. 3 is a sectional view taken along plane A-A′ in FIG. 2;

FIG. 4 is a schematic circuit diagram showing a practicable construction of a data line driver circuit 140 in FIG. 1;

FIG. 5 is a timing chart showing various signals;

FIG. 6 is a timing chart showing a clock CLK and enable signals ENB1 to ENB4 in the case when image signals are fed to four data lines in time division within one clock CLK period;

FIG. 7 is a schematic showing an electronic equipment according to the present invention;

FIG. 8 is a schematic showing another electronic equipment according to the present invention; and

FIG. 9 is a schematic showing still another electronic equipment according to the present invention.

### DETAILED DESCRIPTION OF PREFERRED EMBODIMENTS

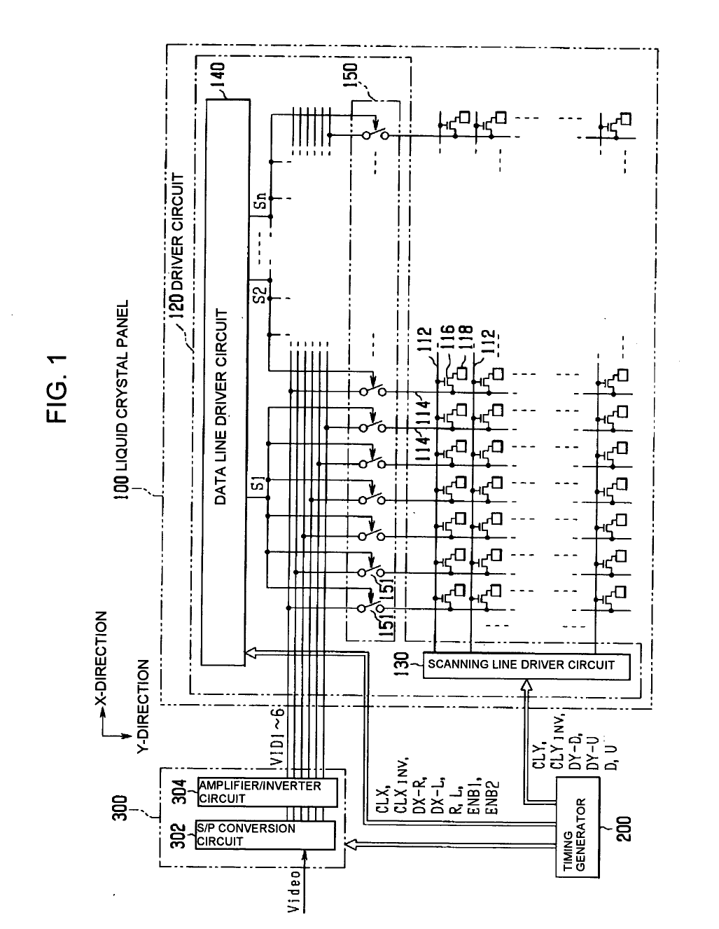

Exemplary embodiments of the present invention are described below with reference to the drawings. FIG. 1 is a schematic showing an electro-optical device according to a first exemplary embodiment of the present invention. This exemplary embodiment is an example in which the invention is applied to a liquid crystal device employing a liquid crystal as an electro-optical substance.

In this exemplary embodiment, the logical status of a clock signal CLX or the inverted signal CLXᵢₙᵥ thereof is prevented from changing at a timing at which image signals are fed to data lines, that is, in the active period of an enable signal and a period vicinal thereto in which the enable signal permits the feed of the image signals to the data lines, whereby the level of noise to be mixed into the image signals is lowered.

As shown in FIG. 1, the liquid crystal device includes a liquid crystal panel 100, a timing generator 200, and an image signal processor circuit 300. Among them, the timing generator 200 outputs timing signals, control signals, etc., which are used in various portions. An S/P conversion circuit 302 in the image signal processor circuit 300 subjects an inputted image signal Video of one loop to serial-to-parallel conversion and outputs the resulting image signals of six loops in order to write them on the basis of phase expansion. The reason why the image signal is subjected to the serial-to-parallel conversion into the six loops is that, in a sampling circuit 150, a time period to apply the image signal to the source region of a thin film transistor (hereinafter “TFT”) which constructs each sampling switch 151 is lengthened to sufficiently secure a sampling time period and charge/discharge time periods.

An amplifier/inverter circuit 304 inverts image signals resulting from the serial-to-parallel conversion which need to be inverted, and thereafter amplifies the inverted image signals as necessity, so as to feed as image signals VID1 to VID6 to the liquid crystal panel 100 in parallel. Whether or not the image signals are inverted is generally determined in accordance with whether a scheme to apply data signals is based on polarity inversion in units of scanning lines 112, polarity inversion in units of data lines 114 or polarity inversion in pixel units, and the cycle of the inversion is set at one horizontal scanning period or dot clock cycle. This exemplary embodiment is described below by taking the case of the polarity inversion in units of the scanning lines 112 as an example for the sake of convenience, but the present invention shall not be construed to be restricted thereto.

The “polarity inversion” signifies to alternately invert the voltage levels of the image signals to a positive polarity and a negative polarity with a reference potential set at the center potential of the amplitudes of the image signals. Timings at which the image signals VID1 to VID6 of the six loops are fed to the liquid crystal panel 100 are simultaneous in the liquid crystal device shown in FIG. 1, but they may well be sequentially shifted in synchronism with dot clocks. In this case, the image signals of the six loops are sequentially sampled by a sampling circuit described below.

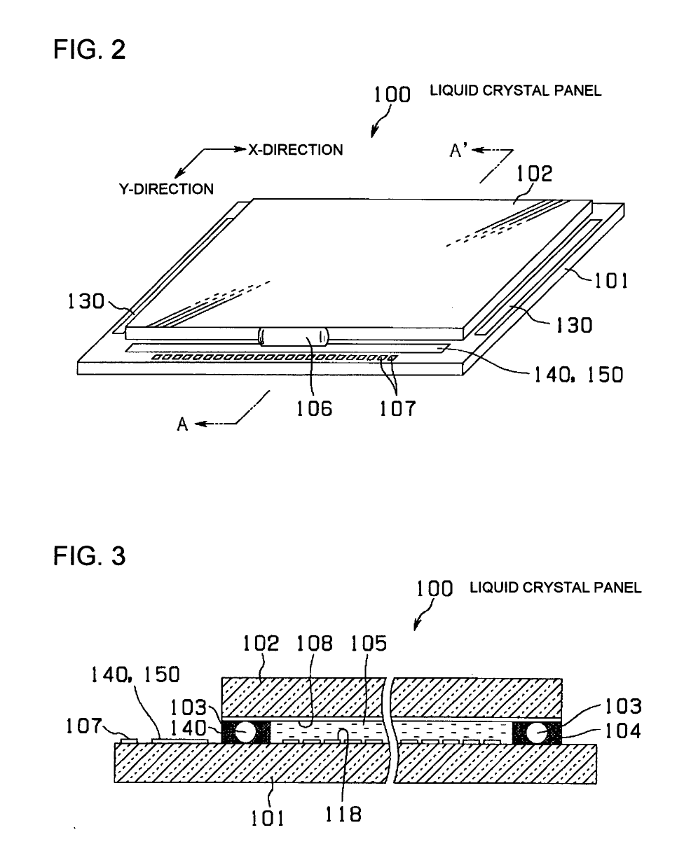

FIG. 2 is a perspective view showing the construction of the liquid crystal panel 100 in FIG. 1, while FIG. 3 is a sectional view taken along plane A-A′ in FIG. 2.

The liquid crystal panel 100 is so constructed that an element substrate 101 formed with various elements, pixel electrodes 118, etc., and a counter substrate 102 provided with a counter electrode 108, etc., are stuck together, with a predetermined gap held therebetween by a sealing member 104 containing spacers (not shown) and with their electrode formation surfaces opposing each other, and that a liquid crystal 105 of, for example, TN (Twisted Nematic) type is enclosed in the gap as an electro-optical substance.

Glass, a semiconductor, quartz or the like is employed for the element substrate 101, while glass or the like is employed for the counter substrate 102. In a case where an opaque substrate is employed as the element substrate 101, the liquid crystal panel is used as a reflection type, not as a transmission type. The sealing member 104 is formed along the peripheral edge of the counter substrate 102, and it is partially opened in order to enclose the liquid crystal 105. Therefore, after the liquid crystal 105 has been enclosed, the open part is sealed by a sealant 106.

Next, a data line driver circuit described below is formed on the counter surface of the element substrate 101 and in a region 140, one latus outside of the sealing member 104, so as to output sampling signals. Further, image signal lines, the sampling circuit, etc., may well be formed in the region 150 of the latus in the vicinity of the sealing member 104 to-be-formed. On the other hand, a plurality of mount terminals 107 are formed at the outer peripheral parts of the latus so as to input various signals from external circuits (not shown).

Scanning line driver circuits are respectively formed in the regions 130 of two latera adjacent to the above latus, so as to drive the scanning lines from both sides. If the delay of scanning signals to be fed to the scanning lines does not pose a problem, a construction in which only one scanning line driver circuit is formed on one side may well be adopted.

The counter electrode 108 provided on the counter substrate 102 is constructed so as electrically connected with the element substrate 101 by a conductive material at, at least, one of the four corners of a sealing portion by which the counter substrate 102 is stuck with the element substrate 101.

Further, if necessary, colored layers (color filters) are provided in the regions of the counter substrate 102 opposing to the pixel electrodes 118, though not especially illustrated. However, in a case where the liquid crystal panel is applied for the use of color light modulation as in a multiple-plate type projector described below, the counter substrate 102 need not be formed with the colored layers.

Orientation films (omitted from FIG. 3) subjected to rubbing treatment are respectively provided on the opposing surfaces of the element substrate 101 and the counter substrate 102. Polarizers (not shown) conforming to the orientation directions of the orientation films are respectively disposed on the rear surface sides of the substrates 101, 102. In FIG. 3, although the counter electrode 108, pixel electrodes 118, mount terminals 107, etc. are made thick as a convenient measure to clarify their formation positions, they are actually thin enough to be neglected relative to the substrates.

The liquid crystal panel 100 is formed on the element substrate with the plurality of scanning lines 112 arrayed in parallel in an X-direction as shown in FIG. 1, and with the plurality of data lines 114 in parallel in a Y-direction orthogonal to the X-direction. At the intersection points between the scanning lines 112 and the data lines 114, the gate electrodes of TFTs 116, which are switches to control individual pixels, are connected to the scanning lines 112, while the source electrodes of the TFTs 116 are connected to the data lines 114, and the drain electrodes of the TFTs 116 are connected to the pixel electrodes 118. In addition, the pixels are respectively constituted by the pixel electrodes 118, the common electrode formed on the counter substrate, and the liquid crystal held between both of these electrodes, with the result that they are arrayed in the shape of a matrix in correspondence with the intersection points between the scanning lines 112 and the data lines 114. Incidentally, a storage capacitor (not shown) may well be further formed electrically in parallel with the liquid crystal held between the corresponding pixel electrode 118 and the common electrode for every pixel.

A driver circuit 120 includes, at least, the scanning line driver circuit 130, the data line driver circuit 140 and the sampling circuit 150. The constituent elements of the driver circuit 120 are constructed by combining P-channel TFTs and N-channel TFTs which are formed by a manufacturing process common to that of the TFTs 116 for driving the pixels, so that the enhancement of a manufacturing efficiency, the lowering of a manufacturing cost, the homogenization of element characteristics, etc., are attained.

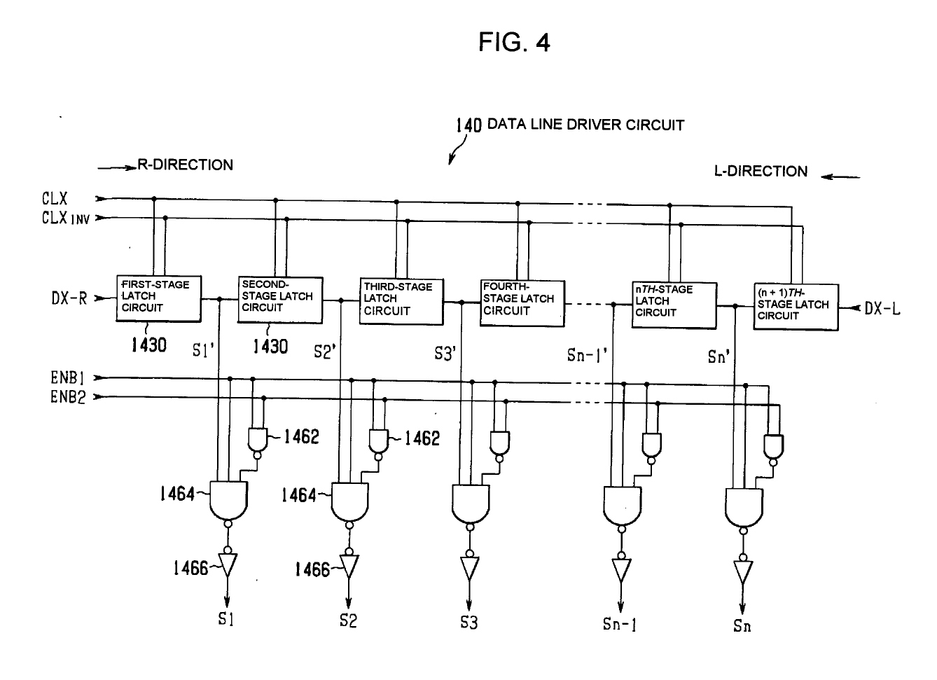

FIG. 4 is a schematic circuit diagram showing a practicable construction of the data line driver circuit 140 in FIG. 1.

The data line driver circuit 140 operates so that a transfer start pulse DX-R or DX-L fed at the outset of a horizontal scanning period is sequentially shifted in accordance with the clock signal CLX and the inverted clock signal CLXᵢₙᵥ thereof, thereby to output the sampling signals S1 to Sn in a predetermined sequence.

The clock signal CLX as well as the inverted clock signal CLXᵢₙᵥ thereof, the transfer start pulse DX-R (DX-L) and enable signals (pulse width limitation signals) ENB1, ENB2 to be fed to the data line driver circuit 140 are all fed in synchronism with the image signals VID1 to VID6 by the timing generator 200 in FIG. 1. Actually used as these signals are signals obtained in such a way that low logic amplitude signals fed from the timing generator 200 are converted into high logic amplitude signals by level shifters (not shown). The reason why logic amplitudes are converted in this manner, is that the timing generator 200 for feeding the various signals to the liquid crystal panel 100 is generally constructed of CMOS circuits and therefore produces output voltages of about 3 to 5 V, whereas the constituent elements of the data line driver circuit 140 are TFTs formed by the same process as that of the TFTs 116 to drive the pixels and therefore require comparatively high operating voltages of about 12 V.

The data line driver circuit 140 includes latch circuits 1430 which are connected in (n+1) stages. One latch circuit 1430 latches and outputs the last input level and feeds it as the input signal of the latch circuit 1430 located at the succeeding stage at the time of the level transitions (rise and fall) of the clock signal CLX and the inverted clock signal CLXᵢₙᵥ thereof.

Each latch circuit 1430 is capable of transfers in both the directions of an R-direction and an L-direction in the figure. In case of the R-directional transfer, the transfer start pulse DX-R is inputted from the left side of the latch circuit 1430, whereas in case of the L-directional transfer, the transfer start pulse DX-L is inputted from the right side of the latch circuit 1430. Therefore, the “succeeding stage” signifies the right side in the case of the R-directional transfer, and the left side in the case of the L-directional transfer. In driving the data line driver circuit 140 in both the directions, the enable signals ENB1, ENB2 need not be changed-over in accordance with the transfer directions by setting the number n of stages at an odd number, so that the load of the external circuit can be lowered.

Letter i is for generalizing the latch circuits 1430 of the first stage to the (n+1)th stage in the description. The data line driver circuit in FIG. 4 is capable of the transfers in both the directions. A signal Si′ (a signal outputted from the latch circuit 1430 of the ith stage in the case of the R-directional transfer, or a signal outputted from the latch circuit 1430 of the (i+1)th stage in the case of the L-directional transfer) is fed to the first input node of a 3-input NAND circuit 1464. The second input node of the NAND circuit 1464 is fed with the enable signal ENB1 for the ordinal number i being odd, or with the enable signal ENB2 for the ordinal number i being even. Further, the third input node of the NAND circuit 1464 is fed with the output signal of a NAND circuit 1462, more specifically, the negative logical product signal of the enable signals ENB1 and ENB2.

The enable signals ENB1, ENB2 are signals which are used in order to prevent the adjacent ones of the signals S1′ to Sn′ from simultaneously becoming an H level, each of which has a pulse width shorter than the half cycle of the clock signal CLX (or inverted clock signal CLXᵢₙᵥ), and which ought not to overlap each other.

The output signals of the NAND circuits 1464 corresponding to the individual stages are inverted by inverters 1466, and the inverted signals are outputted as the sampling signals S1 to Sn of the data line driver circuit 140, respectively. Inverters 1466 may well be configured of an inverter of a single stage, or inverters of a plurality of stages, such as three stages or five stages.

In this exemplary embodiment, the enable signals ENB1, ENB2 are set at L level periods disabling the sampling, at the rise or fall timings of the clocks CLK, CLKᵢₙᵥ and in a period vicinal thereto by the timing generator 200.

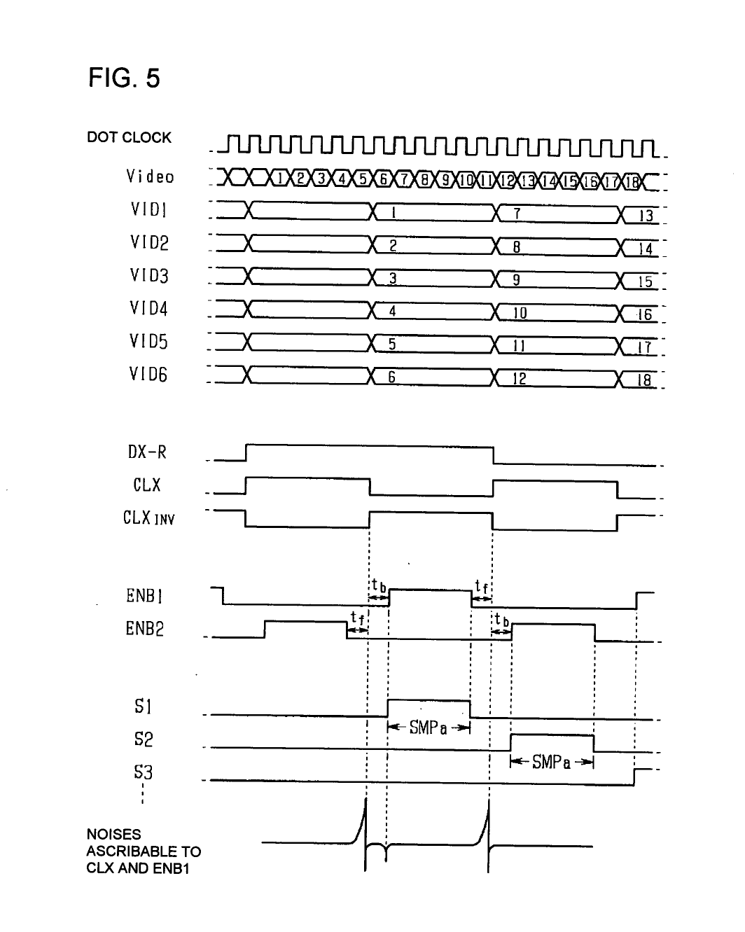

FIG. 5 is a timing chart showing various signals.

As shown in FIG. 5, the enable signals ENB1, ENB2 rise after a period “tb” since the rise timing of the clock CLX (the fall timing of the clock CLXᵢₙᵥ), and they fall before a period “tf” since the fall timing of the clock CLX (the rise timing of the clock CLXᵢₙᵥ). In this exemplary embodiment, the periods “tb”, “tf” are set at time periods of, for example, at least 15 nanoseconds. Alternatively, they are set at time periods of 15 to 20 nanoseconds.

As stated below, the image signals are sampled and fed to the data lines in the H periods of the enable signals ENB1, ENB2. Due to timing settings in FIG. 5, accordingly, neither of the clocks CLX, CLXᵢₙᵥ rises or falls in the periods in which the image signals are sampled and fed to the data lines, so that high frequency noise ascribable to the rise or fall is reduced or prevented from mixing into the image signals.

Assuming that the rise and fall timings of the enable signals ENB1, ENB2 and the rise or fall timings of the clocks CLX, CLXᵢₙᵥ arise in proximity, the high frequency noises of both the signals are combined to greatly affect the image signals. However, Since the rise and fall timings of the enable signals ENB 1, ENB2 are set at the timings which are sufficiently distant from the rise or fall timings of the clocks CLX, CLXᵢₙᵥ, the levels of the high frequency noises to be mixed into the image signals can be relieved.

Referring back to FIG. 1, the sampling circuit 150 sets every six data lines 114 as one group (block), and it samples the respective image signals VID1 to VID6 and feeds them to the data lines 114 belonging to such groups, in accordance with the sampling signals S1 to Sn. More specifically, the sampling circuit 150 includes the switches 151, which are disposed for the respective data lines 114. Each of the switches 151 is interposed between one end of the corresponding data line 114 and a signal line which is fed with any of the image signals VID1 to VID6, and its gate is fed with the sampling signal.

The scanning line driver circuit 130 has basically the same construction as that of the data line driver circuit 140, except that the direction of leading out the output signals, and signals to be inputted are different. More specifically, the scanning line driver circuit 130 is such that the data line driver circuit 150 is arranged after being turned 90 degrees counterclockwise. As shown in FIG. 1, a pulse DY-D (DY-U) and a transfer control signal D (U) are inputted to this circuit 130 instead of the pulse DX-R (DX-L) and the transfer control signal R (L), and a clock signal CLY and the inverted clock signal CLYᵢₙᵥ thereof are inputted for every horizontal scanning period instead of the clock signal CLX and the inverted clock signal CLXᵢₙᵥ thereof.

In a case where a vertical scanning direction is the down direction, the pulse DY-D is fed at the outset of a vertical scanning period, and the transfer control signal D is activated. In contrast, in a case where the vertical scanning direction is the up direction, the pulse DY-U is fed at the outset of the vertical scanning period, and the transfer control signal U is activated. The clock signal CLY, the inverted clock signal CLYᵢₙᵥ thereof and the pulse DY-U (or DY-D) are fed in synchronism with the image signals VID1 to VID6 by the timing generator 200 in FIG. 1. Further, these signals and the transfer control signal R (L) have all been converted into signals of high logic amplitudes by level shifters (not shown).

By setting the frequencies of these clock signals to be low, it is sufficiently possible that the scanning signals which are fed to the adjacent ones of the scanning lines be substantially reduced or prevented from overlapping. Therefore, no problem is posed even when the scanning line driver circuit 130 is endowed with a simple construction which is based on a NAND circuit to narrow a pulse width, and an inverter succeeding it.

The operation of an exemplary embodiment thus constructed is described below. In the ensuing description, it is assumed for the sake of convenience that the vertical scanning direction be the down direction, while the horizontal scanning direction be the rightward (R) direction.

The scanning line driver circuit 130 is fed with the pulse DY-D at the outset of a vertical scanning period, and this pulse DY-D is sequentially shifted by the clock signal CLY and the inverted clock signal CLYᵢₙᵥ thereof so as to be outputted to the respective scanning lines 112. Thus, the plurality of scanning lines 112 are selected in the down direction in line sequence one by one.

Due to the image signal processor circuit 300, the image signal Video of one loop is distributed into the image signals VID1 to VID6 and is lengthened 6 times with respect to a time axis as shown in FIG. 5. Further, at the outset of a period in which a certain one of the scanning lines is selected, that is, at the outset of a horizontal scanning period, the data line driver circuit 140 is fed with the transfer start pulse DX-R as shown in the figure.

In an ordinary operation, the enable signals ENB1, ENB2 are fed from the timing generator 200 so that, as shown in FIG. 5, the H level (active) periods thereof may not overlap each other. Therefore, the output signal of the NAND circuit 1462 in FIG. 4 continues to be at the H level and does not transits to an L level. For this reason, the output of the NAND circuit 1464 depends upon only the signal Si and the enable signal ENB1, for the ordinal number i being odd, and it depends upon only the signal Si and the enable signal ENB2, for the ordinal number i being even.

Therefore, the signals S1′ to Sn′, which are obtained in such a way that the transfer start pulse DX-R fed at the outset is sequentially shifted for every half cycle of the clock signal CLX as well as the inverted clock signal CLXᵢₙᵥ thereof by the latch circuits 1430 of the first stage to the nth stage, are limited within the H level periods SMPa of the enable signals ENB1, ENB2. They are sequentially outputted as the sampling signals S1 to Sn as shown in FIG. 5.

When the sampling signal S1 has become the H level, the image signals VID1 to VID6 are respectively sampled onto the six data lines 114 belonging to this group, and these image signals VID1 to VID6 are respectively written into the six pixels intersecting with the scanning line 112 selected at the current time, by the corresponding TFTs 116. Subsequently, when the sampling signal S2 has become the H level, the image signals VID1 to VID6 are respectively sampled onto the next six data lines 114 on this occasion, and these image signals VID1 to VID6 are respectively written into the six pixels intersecting with the scanning line 112 selected at that time, by the corresponding TFTs 116.

Similarly to the above, when the sampling signals S3, S4 . . . , and Sn have become the H level in sequence, the image signals VID1 to VID6 are respectively sampled onto the six data lines 114 belonging to each of the sampling signals, and these image signals VID1 to VID6 are respectively written into the six pixels intersecting with the scanning line 112 selected at that time. Thereafter, the next scanning line 112 is selected, the sampling signals S1 to Sn are sequentially outputted again, and similar writing is iteratively executed.

In the sampling periods based on the H levels of the enable signals ENB1, ENB2, noises are superposed on the image signals of the respective data lines. Especially, the influences of high frequency noises ascribable to the clocks CLX, CLXᵢₙᵥ and the enable signals ENB1, ENB2 which rise and fall in units of the plurality of pixels in the horizontal direction appear as line blurs in the vertical direction and incur the drastic degradation of an image quality.

In this exemplary embodiment, however, the start timing and end timing of each sampling period based on the H level of the enable signal ENB1 or ENB2 are set to be sufficiently distant from the rise and fall timings of the clocks CLX, CLXᵢₙᵥ. Thus, the high frequency noises ascribable to the clocks CLX, CLXᵢₙᵥ and the enable signals ENB 1, ENB2 are large in periods other than the sampling periods and are comparatively small in the sampling periods as shown in FIG. 5. The high frequency noise ascribable to the clocks CLX, CLXᵢₙᵥ and the high frequency noise ascribable to the enable signal ENB1 or ENB2 have sufficient distant generation timings, and noise of large level resulting from the addition of both the noises does not develop, so that the level of noise to be mixed into the image signal is comparatively small.

In this manner, in the settings of this exemplary embodiment, the rises and falls of the clocks CLX, CLXᵢₙᵥ are not generated in the H level periods of the enable signals ENB1, ENB2 for setting the sampling periods, and the rises and falls of the enable signals ENB1, ENB2 and those of the clocks CLX, CLXᵢₙᵥ are generated at the sufficiently distant timings, whereby the levels of the high frequency noises to be mixed into the image signals which are fed to the data lines are reduced to prevent the vertical direction line blurs from being displayed on a screen and to enhance a screen quality.

The first exemplary embodiment is described above assuming the horizontal scanning direction to be the rightward (R) direction. To the contrary, in a case where the horizontal scanning direction is the leftward (L) direction, the construction of each latch circuit 1430 in the R-direction transfer mode is bilaterally reversed. In this case, therefore, it is only different that the sampling signals are outputted in the sequence of Sn, S(n−1) . . . , S2 and S1, and hence, the operation shall be omitted from description. Also in a case where the vertical scanning period is in the up direction, the operation is similar.

In the above description, the sampling circuit 150 is so constructed that the image signals VID1 to VID6 converted into the six loops are simultaneously sampled and fed to the six data lines 114 forming one group, and that the image signals VID1 to VID6 are sequentially applied to the respective data line groups. However, the number of converted loops and the number of data lines to which the image signals are simultaneously applied (that is, the number of data lines constituting one group) are not restricted to “6”. By way of example, if the response rate of each switch 151 in the sampling circuit 150 is sufficiently high, a construction may well be adopted in which the image signals are serially transmitted to a single signal line without being deserialized, so as to be sequentially sampled onto the respective data lines 114. It is also allowed to adopt a construction in which the number of converted loops and the number of data lines to which the image signals are simultaneously applied are set at, for example, “3”, “12” or “24”, and 3-loop conversion, 12-loop conversion or 24-loop conversion, for example, is performed for the data lines numbering, for example, 3, 12 or 24, whereby the image signals fed in parallel are simultaneously fed. As the number of converted loops and the number of data lines to which the image signals are simultaneously applied, any multiple of “3” is favorable to simplify controls, circuits, etc., in relation to the fact that a color image signal is composed of signals based on three primary colors.

In the exemplary embodiment described above, the switching elements of the pixels have been explained as 3-terminal elements represented by the TFTs, but they may well be constructed of 2-terminal elements, such as diodes. However, in case of employing the 2-terminal elements as the switching elements of the pixels, it is necessary to form the scanning lines 112 on one substrate and the data lines 114 on the other substrate, and to form the 2-terminal elements between either the scanning lines 112 or the data lines 114 and the pixel electrodes 118. In this case, each pixel is constituted by the pixel electrode 118 to which the 2-terminal element is connected, the signal line (either the data line 114 or the scanning line 112) which is formed on the counter substrate, and the liquid crystal which is held between the pixel electrode and the signal line.

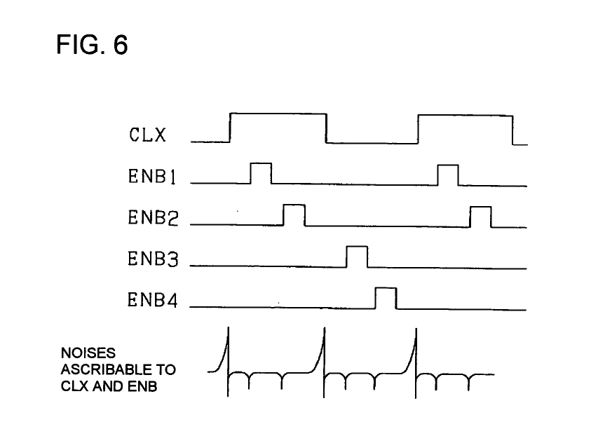

The above exemplary embodiment is described as to the example in which one enable signal ENB1 or ENB2 is generated for one clock CLX or CLXᵢₙᵥ. Further, it is possible to adopt a method in which a plurality of enable signals ENB1, ENB2, . . . are generated for one clock CLX or CLXᵢₙᵥ so as to feed image signals to a plurality of data lines in time division within one clock CLK period. FIG. 6 is a timing chart showing a clock CLK and enable signals ENB1 to ENB4 in the case where image signals are fed to four data lines in time division within one clock CLK period.

As shown in FIG. 6, the enable signals ENB1, ENB2 are activated in the H level period of the clock CLK, and the enable signals ENB3, ENB4 are activated in the L level period of the clock CLK. Accordingly, by using the enable signals ENB1 to ENB4, the image signals corresponding to the four data lines can be sampled in time division within one cycle of the clock CLK so as to be fed to the four corresponding data lines.

Also in FIG. 6, neither the rise nor fall of the clock CLK is generated in the H level periods of the enable signals ENB1 to ENB4 to set sampling periods. Moreover, the rises and falls of the enable signals ENB1 to ENB4 and those of the clock CLK are generated at sufficiently distant timings.

Thus, also in this case, the levels of high frequency noises to be mixed into the image signals which are fed to the data lines can be reduced as shown in FIG. 6, thereby to reduce or prevent vertical direction line blurs from being displayed on a screen and to enhance a screen quality.

Incidentally, although the example adopting the liquid crystal as the electro-optical substance has been described in the above exemplary embodiment, the present invention is also applicable to a display device which employs electro luminescent elements or the likes so as to present a display on the basis of the electro-optical effect thereof. That is, the present invention is applicable to any electro-optical device, which has a construction similar to that of the foregoing liquid crystal device.

Cases are described below where the liquid crystal device described above is applied to each of various exemplary electronic equipment.

<#1: Projector>

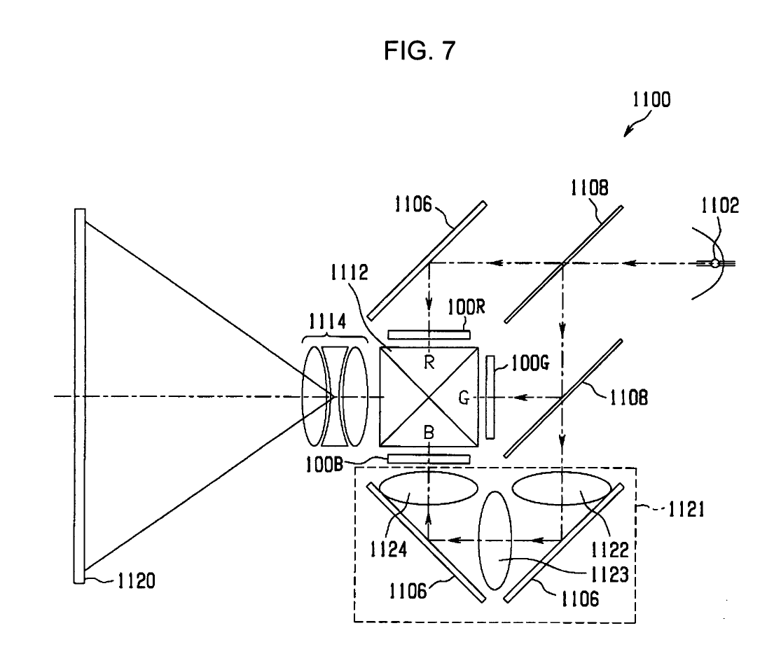

A projector is described below which employs the liquid crystal panel as a light valve. FIG. 7 is a plan view showing the construction of the projector. As shown in FIG. 7, a lamp unit 1102 which includes a white light source, such as halogen lamp, is disposed inside the projector 1100. Projection light emitted from the lamp unit 1102 is decomposed into three primary colors RGB by three mirrors 1106 and two dichroic mirrors 1108 which are arranged inside, and the light components R, G and B are respectively guided to the liquid crystal panels 100R, 100G and 100B which serve as the light valves corresponding to the primary colors.

The light of the color B has an optical path which is longer as compared with those of the lights of the other colors R and G, and hence, in order to reduce or prevent the loss thereof, it is guided through a relay lens system 1121 which includes an entrance lens 1122, a relay lens 1123, and an exit lens 1124.

The liquid crystal panels 100R, 100B and 100G have constructions each of which is equivalent to that of the liquid crystal panel 100 described above, and they are respectively driven by primary color signals R, B, G which are fed from image signal processor circuits (not shown). Subsequently, the lights modulated by these liquid crystal panels are entered into a dichroic prism 1112 from three directions. In the dichroic prism 1112, the lights of the colors R and B are refracted at 90 degrees, whereas the light of the color G proceeds rectilinearly. Accordingly, the images of the respective colors are composed, with the result that a color image is projected on a screen 1120 through a projection lens assembly 1114.

When focused on the display images based on the respective liquid crystal panels 100R, 100B and 100G, the display image based on the liquid crystal panel 100G needs to be bilaterally inverted with respect to the display images based on the liquid crystal panels 100R and 100B. Therefore, horizontal scanning directions are in the relationship of reverse directions to each other between in the liquid crystal panel 100G and in each of the liquid crystal panels 100R, 100B. Since the lights corresponding to the respective primary colors R, B and G are entered into the liquid crystal panels 100R, 100B and 100G by the dichroic mirrors 1108, color filters need not be disposed.

<#2: Mobile Type Computer>

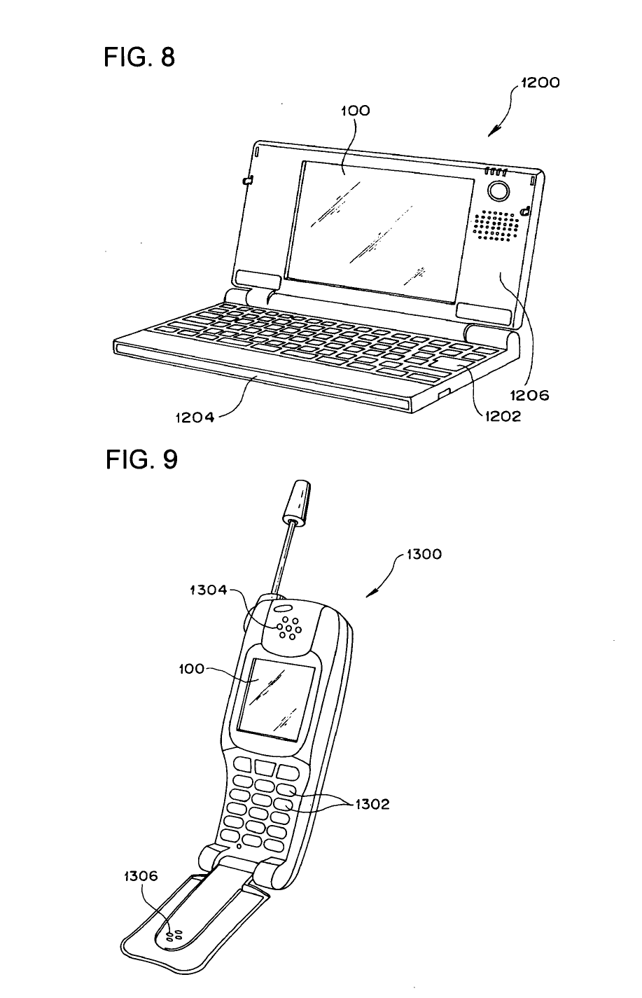

An example is described below in which the liquid crystal panel is applied to a personal computer of a mobile type. FIG. 8 is a perspective view showing the construction of this personal computer. Referring to FIG. 8, the computer 1200 is constructed of the body portion 1204 including a keyboard 1202, and a liquid-crystal display unit 1206. This liquid-crystal display unit 1206 is constructed by adding a backlighting unit onto the rear side of the liquid crystal panel 100 discussed above.

<#3: Portable Telephone>

An example is described below in which the liquid crystal panel is applied to a portable telephone. FIG. 9 is a perspective view showing the construction of this portable telephone. Referring to FIG. 9, the portable telephone 1300 includes the liquid crystal panel 100 together with a plurality of operating buttons 1302 and an earpiece 1304 as well as a mouthpiece 1306. Also the liquid crystal panel 100 is furnished with a backlighting unit on its rear side as may be needed.

Apart from the electronic equipment described with reference to FIGS. 7 to 9, other types of electronic equipment include: a liquid crystal television set, a video tape recorder of view finder type or monitor direct-view type, a car navigation system, a pager, an electronic notebook, a desktop calculator, a word processor, a workstation, a video telephone, a POS terminal, an equipment including a touch panel, etc., for example.

The liquid crystal devices and further the electro-optical devices in the respective exemplary embodiments are applicable to these and other various electronic equipment.

As described above, according to the present invention, the logical status of a clock signal CLX or the inverted signal CLXᵢₙᵥ thereof is prevented from changing in an active enable signal period and a period vicinal thereto, thereby to bring forth the advantage that the level of noise to be mixed into an image signal can be lowered to reduce or suppress a vertical line blur.

What is claimed is:

1. An electro-optical device, comprising:
a plurality of scanning lines and a plurality of data lines;
switching elements disposed in correspondence with intersection parts between the scanning lines and the data lines;
pixel electrodes disposed in correspondence with the switching elements;
video signal lines which transmit image signals;
a data line drive device to sample the image signals transferred by the video signal lines and feed the signals to the data lines, by using a clock which serves as reference of horizontal scanning and an enable signal which determines timings to feed the image signals to the data lines; and
a timing generation device to set active periods of the enable signal which make the sampling of the image signals possible, in periods which do not include timings of rise or fall of the clock.

2. The electro-optical device according to claim 1, the timing generation device setting the active periods of the enable signal, in periods which are other than a period of predetermined width including the timing of the rise or fall of the clock.

3. The electro-optical device according to claim 2, the period of the predetermined width being a period which is distant from the timing of the rise or fall of the clock more than 15 nanoseconds.

4. The electro-optical device according to claim 1, the enable signal having a plurality of active periods within one cycle of the clock which serves as the reference of the horizontal scanning.

5. An electro-optical device, comprising:
a plurality of scanning lines and a plurality of data lines;
switching elements disposed in correspondence with intersection parts between the scanning lines and the data lines;
pixel electrodes disposed in correspondence with the switching elements;
video signal lines which transmit image signals;
a data line driver circuit which samples the image signals transferred by the video signal lines and feed the signals to the data lines, by using a clock that serves as reference of horizontal scanning and an enable signal that determines timings to feed the image signals to the data lines; and
a timing generator circuit which sets those active periods of the enable signal that make the sampling of the image signals possible, in periods that do not include timings of rise or fall of the clock.

6. The electro-optical device according to claim 5, the timing generator circuit setting the active periods of the enable signal, in periods which are other than a period of predetermined width including the timing of the rise or fall of the clock.

7. The electro-optical device according to claim 5, the enable signal having a plurality of active periods within one cycle of the clock which serves as the reference of the horizontal scanning.

8. A driver circuit for an electro-optical device, comprising:
a data line driver circuit which samples image signals transferred by video signal lines and feeds the signals to the data lines, by using a clock that serves as reference of horizontal scanning and an enable signal that determines timings to feed the image signals to the data lines; and
a timing generator circuit which setting those active periods of the enable signal that make the sampling of the image signals possible, in periods that do not include timings of rise or fall of the clock.

9. The driver circuit for an electro-optical device according to claim 8, the timing generator circuit setting the active periods of the enable signal, in periods which are other than a period of predetermined width including the timing of the rise or fall of the clock.

10. The driver circuit for an electro-optical device according to claim 8, the enable signal having a plurality of active periods within one cycle of the clock which serves as the reference of the horizontal scanning.

11. A drive method of driving an electro-optical device, comprising:
feeding a clock which serves as a reference of horizontal scanning, and an enable signal which determines timings to feed data lines with image signals transferred by video signal lines;
setting active periods of the enable signal which make sampling of the image signals possible, in periods which do not include timings of rise or fall of the clock; and
sampling the image signals and feeding the signals to the data lines in the active periods of the enable signal.

12. The drive method of driving an electro-optical device according to claim 11, timings of rise or fall of the clock and the active periods of the enable signal being periods which are distant from the timings of the rise or fall of the clock more than 15 nanoseconds.

13. An electronic equipment, comprising:
the electro-optical device according to claim 1 usable as an image formation device.
